(19) United States
(12) Patent Application Publication
(10) Pub. No.: US 2020/0064860 A1
(43) Pub. Date: Feb. 27, 2020

(54) UNMANNED GUIDED VEHICLE AND SYSTEM USING VISIBLE LIGHT COMMUNICATION

(71) Applicant: YUYANG DNU CO., LTD., Hwaseong-si, Gyeonggi-do (KR)

(72) Inventors: Sangok KIM, Seoul (KR); Byungoh KIM, Suwon-si (KR); Sang-ho YOON, Suwon-si (KR); Seung-wan ROH, Suwon-si (KR)

(21) Appl. No.: 16/466,064

(22) PCT Filed: Dec. 1, 2017
(86) PCT No.: PCT/KR2017/013989

§ 371 Date: Jun. 3, 2019

(30) Foreign Application Priority Data
Dec. 5, 2016 (KR) 10-2016-0164502

(51) Int. Cl. G05D 1/02; H04B 10/116; H04B 10/66; H04B 10/50; H04B 10/80; G05D 1/00

(52) U.S. Cl. CPC G05D 1/0276; H04B 10/116; H04B 10/66; G05D 2201/0216; H04B 10/80; G05D 1/0088; G05D 1/0212; H04B 10/50

(57) ABSTRACT

An unmanned guided vehicle and system using visible light communication are disclosed. According to one aspect of the present disclosure, there is provided an unmanned guided vehicle configured to move according to a visible light signal received from a lighting device, the unmanned guided vehicle including a visible light receiver configured to receive a visible light signal from the lighting device, a data manager configured to demodulate the visible light signal into an electric signal to check data included in the visible light signal or to generate state information to be transmitted to the lighting device, a lighting unit configured to modulate the state information into a visible light signal and transmit the visible light signal to the lighting device, a drive unit configured to control steering and driving of the unmanned guided vehicle, and a controller configured to analyze the data included in the visible light signal and control the drive unit to drive or rotate the unmanned guided vehicle.

### TECHNICAL FIELD

The present invention relates to an unmanned guided vehicle and an unmanned guidance system using visible light communication.

### BACKGROUND

The statements in this section merely provide background information related to the present disclosure and may not constitute prior art.

Various unmanned guided vehicles for transporting materials, semi-finished products or parts are used on industrial sites such as production lines and assembly lines.

An unmanned guided vehicle is an apparatus that transports materials and products through production processes on an automated production line.

The unmanned guided vehicle operates according to a command received from a host computer, using electric power stored in a battery as a power source. Such unmanned guided vehicles include an automatic guided vehicle (AGV), which moves while reading guide devices arranged on a floor, and a rail guided vehicle (RGV), which moves along a certain track depending on the size and precision of products applied to the system or the difficulty of the operation.

Conventional unmanned guided vehicles require arrangement of additional facilities such as a separate guide device or track on an industrial site. In addition, due to a risk of damage to the provided guide device or track, no product or equipment is allowed to be placed on the guide device or track irrespective of whether the unmanned guided vehicle is operating. Therefore, the area in which the guide device or track is disposed on an industrial site is not usable.

Considering this issue, an unmanned guidance system using wireless communication is emerging. In the case of a recently introduced unmanned guidance system, rather than installing a guide device or track on the floor of an industrial site to guide the unmanned guided vehicle, a radio signal transmitter is installed on the ceiling of an industrial site to guide the unmanned guided vehicle using a radio signal. Since the unmanned guided vehicle is guided using radio signals, the recently introduced unmanned guidance system addresses issues conventionally raised by arrangement of a guide device or a tack on the industrial site.

However, as smart factory technology, which combines industrial facilities with IoT technology, is emerging, it is not easy to apply the recently introduced unmanned guidance systems to smart factories. The smart factory technology is a technology enabling a central management server to receives data from each sensor attached to each facility in the factory by wireless communication and collect and analyze the data in real time. In addition, the smart factory technology is a technology enabling unattended control of each facility in the factory based on the collected and analyzed data as desired. As the smart factory technology is applied to each industrial sites such as factories and wireless communication is used on the industrial sites, the industrial sites become sensitive to wireless communications except for the wireless communication used in the smart factory technology. In such circumstances, it is difficult to apply an unmanned guidance system using the conventional wireless signal on the industrial site where the smart factory technology is applied.

### SUMMARY

Therefore, it is one object of the present invention to provide an unmanned guided vehicle controlled by visible light communication and an unmanned guidance system which controls the unmanned guided vehicle using visible light communication.

In accordance with one aspect of the present invention, provided is an unmanned guided vehicle configured to move according to a visible light signal received from a lighting device, the unmanned guided vehicle including a visible light receiver configured to receive a visible light signal from the lighting device, a data manager configured to demodulate the visible light signal into an electric signal to check data included in the visible light signal or to generate state information to be transmitted to the lighting device, a lighting unit configured to modulate the state information into a visible light signal and transmit the visible light signal to the lighting device, a drive unit configured to control steering and driving of the unmanned guided vehicle, and a controller configured to analyze the data included in the visible light signal and control the drive unit to drive or rotate the unmanned guided vehicle.

As described above, according to an embodiment of the present disclosure, an unmanned guided vehicle is controlled using visible light communication instead of wireless communication, and accordingly the present disclosure is applicable even to an industrial site sensitive to wireless signals.

### BRIEF DESCRIPTION OF DRAWINGS

FIG. 1 is a view illustrating an unmanned guidance system according to an embodiment of the present disclosure.

FIG. 2 is a configuration diagram of a server according to an embodiment of the present disclosure.

FIG. 3 is a configuration diagram of a lighting device according to an embodiment of the present disclosure.

FIG. 4 is a block diagram of an unmanned guided vehicle according to an embodiment of the present disclosure.

FIG. 5 is a diagram illustrating a map of a space in which an unmanned guidance system is operated according to an embodiment of the present disclosure.

### DETAILED DESCRIPTION

Hereinafter, some embodiments of the present disclosure will be described in detail with reference to the accompanying drawings. It should be noted that, in adding reference numerals to the constituent elements in the respective drawings, like reference numerals designate like elements, although the elements are shown in different drawings. Further, in the following description of the present disclosure, a detailed description of known functions and configurations incorporated herein will be omitted when it may make the subject matter of the present disclosure rather unclear.

Additionally, various terms such as first, second, A, B, (a), (b), etc., are used solely for the purpose of differentiating one component from the other but neither imply nor suggest the substances, the order or sequence of the components. Throughout this specification, when a part “includes” or “comprises” a component, the part may further include other components, and such other components are not excluded unless there is a particular description contrary thereto. Terms such as “unit,” “module,” and the like refer to units for processing at least one function or operation, which may be implemented by hardware, software, or a combination thereof.

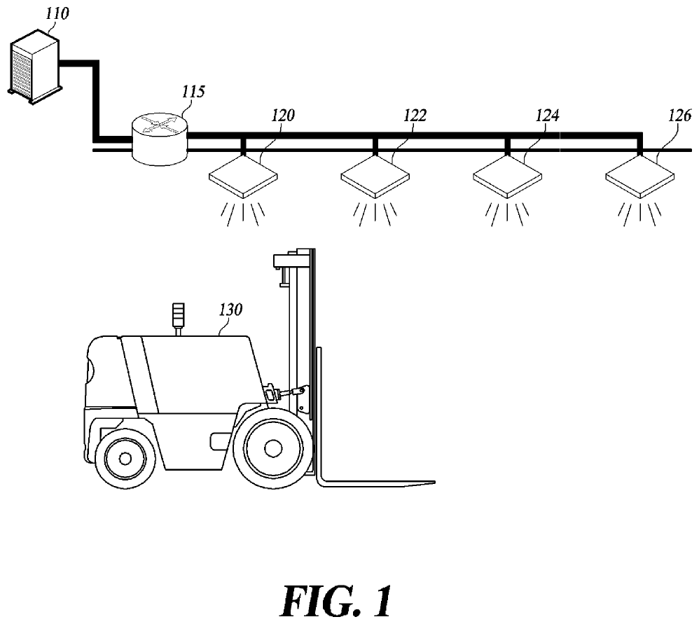

FIG. 1 is a view illustrating an unmanned guidance system according to an embodiment of the present disclosure.

Referring to FIG. 1, an unmanned guidance system 100 according to an embodiment of the present disclosure includes a server 110, lighting devices 120, 122, 124 and 126, and an unmanned guided vehicle 130.

The server 110 is a management apparatus configured to generate control data for the unmanned guided vehicle 130, control the lighting devices 120, 122, 124 and 126 to transmit the control data to the unmanned guided vehicle 130, and receive state information from the unmanned guided vehicle 130, and manage the unmanned guided vehicle 130 by determining whether the unmanned guided vehicle 130 is operating according to the control operation.

The server 110 is connected to the lighting device 120 over a wired network for a control operation. The wired network may include wired communication using Ethernet communication, IEEE 1394 communication, universal serial bus (USB), a wire, a twisted pair of wires, a coaxial cable, an optical link, and the like.

The server 110 generates control data for the unmanned guided vehicle 130 and is connected to the lighting devices 120, 122, 124 and 126 via an aggregator 115 to control the lighting devices 120, 122, 124, and 126 to transmit the control data to the unmanned guided vehicle 130. The server 110 receives instruction information for instructing an operation of the unmanned guided vehicle 130 from the administrator of the unmanned guidance system 100. The server 110 generates data including the instruction information and transmits the data to the lighting devices 120, 122, 124 and 126. The lighting devices 120, 122, 124 and 126 transmit the received data to the unmanned guided vehicle 130 using visible light communication. The server 110 transmits the instruction information of the administrator to the unmanned guided vehicle 130 via the lighting devices 120, 122, 124 and 126 to control the unmanned guided vehicle 130 to operate as instructed by the administrator.

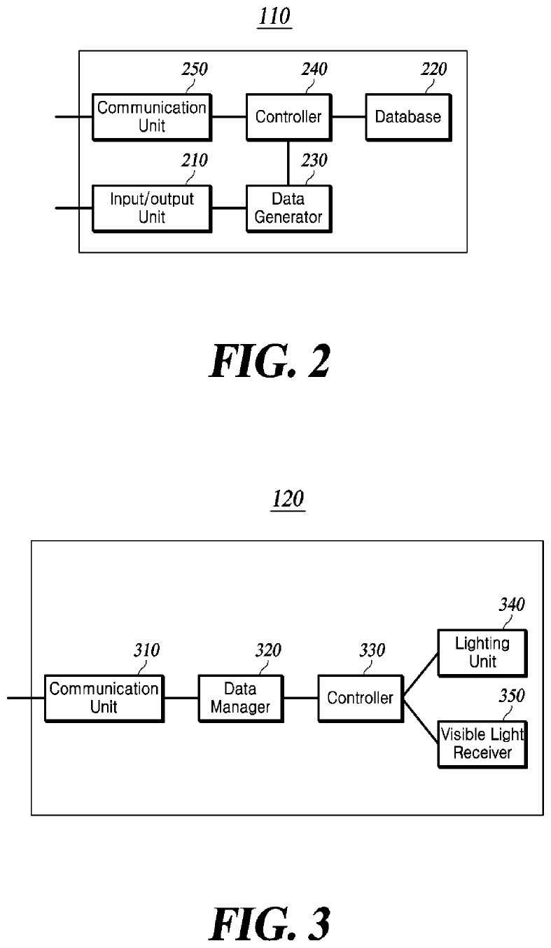

The server 110 receives the state information about the unmanned guided vehicle 130 from the lighting devices 120, 122, 124, and 126, and manages the unmanned guided vehicle 130 by checking whether the unmanned guided vehicle 130 is controlled as instructed. Upon receiving the state information about the unmanned guided vehicle 130, the server 110 checks whether the unmanned guided vehicle 130 is operating as controlled by the server. Upon receiving the state information about the unmanned guided vehicle 130, the server 110 outputs the state information to allow the administrator of the unmanned guidance system 100 to immediately recognize the management state of the unmanned guided vehicle 130. A detailed description of the server 110 will be made with reference to FIG. 2.

The aggregator 115 is a device connected to one or more lighting devices to transmit data received from the server 110 to a lighting device or to collect data transmitted by the one or more lighting devices and deliver the collected data at once or sequentially. The aggregator 115 may be implemented as a separate element between the server 110 and the lighting device 120, or may be implemented as a module in the server 110 to perform the above-described operation in the server 110.

The lighting devices 120, 122, 124, and 126, which are devices configured to emit light, transmit and receive data to and from the server 110 over a wired network, and transmit and receive data to and from the unmanned guided vehicle 130 using visible light communication.

The lighting devices 120, 122, 124, and 126 generate a visible light signal representing data to be transmitted to the terminal by repeating lighting on or off, and transmits the visible light signal to the terminal. Since the lighting devices 120, 122, 124, and 126 repeatedly turn on/off at a speed unnoticeable by the human optic nerve system, the lighting device may maintain the function of lighting while transmitting data. The lighting devices 120, 122, 124, and 126 may be implemented as a light emitting diode (LED), but is not limited thereto. The lighting devices may be replaced with any devices that emit visible light, such as a fluorescent lamp or visible light laser.

The lighting devices 120, 122, 124, and 126 have wired communication modules to enable wired network communication. The lighting devices 120, 122, 124 and 126 receive data that is to be transmitted from the server 110 to the unmanned guided vehicle 130, using wired network communication, or transmit data received from the unmanned guided vehicle 130 to the server 110.

The lighting devices 120, 122, 124, and 126 deliver data to the unmanned guided vehicle 130 or receive data from the unmanned guided vehicle 130, using light in the range of visible light wavelengths. The lighting devices 120, 122, 124, and 126 are connected to the server 110 over a wired network as described above, and receive data having a form transmittable from the server 110 over the wired network. The lighting devices 120, 122, 124, and 126 analyze the received data to check the information contained in the data, generate data having a form transmittable through visible light communication, and transmit the data to the unmanned guided vehicle 130 using visible light communication. In contrast, the lighting devices 120, 122, 124, and 126 receive, from the unmanned guided vehicle 130, data having a form transmittable through visible light communication, and analyze the received data to check the information contained in the data. The lighting devices 120, 122, 124, and 126 generate data having a form transmittable over the wired network and transmit the data including the information to the server 110. A detailed description of the lighting device 120 will be given with reference to FIG. 3.

The unmanned guided vehicle 130 is an apparatus driven under control of the server 110 without human manipulation to transport materials, workpieces, parts, and the like. In contrast with conventional cases, the unmanned guided vehicle 130 transmits and receives data to and from the lighting devices 120, 122, 124 using visible light communication without separate rails or guide devices. The unmanned guided vehicle 130 may be implemented as any type of vehicle, such as an automated guided vehicle (AGV) or an RGV, which is capable of transporting workpieces, parts, and the like without direct manipulation by humans.

The unmanned guided vehicle 130 receives the visible light signal from the lighting devices 120, 122, 124, and 126 using a visible light reception module. The visible light reception module may be implemented as a camera, a photodiode, or the like, but is not limited thereto. Any module capable of receiving visible light may be employed in place of the visible light reception module. The unmanned guided vehicle 130 may have the visible light reception module as a built-in module or an external module. The unmanned guided vehicle 130 receives data over a visible light signal emitted from the lighting devices 120, 122, 124, and 126. Upon receiving the data, the unmanned guided vehicle 130 analyzes the received data and determines whether the transmitted data is intended therefor. When the transmitted data is intended for the unmanned guided vehicle, the unmanned guided vehicle operates according to an instruction contained in the data.

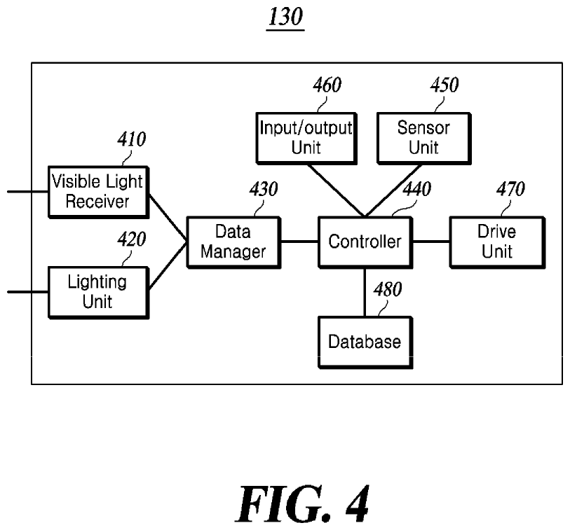

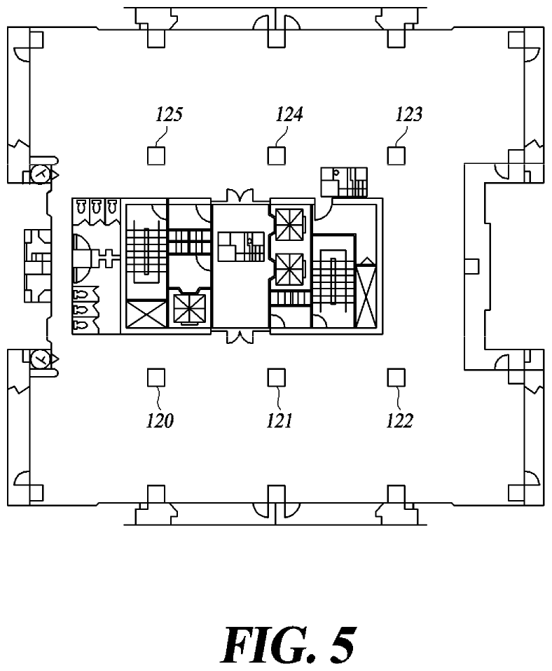

The unmanned guided vehicle 130 includes a lighting unit and transmits a visible light signal to the lighting devices 120, 122, 124, and 126. The unmanned guided vehicle 130 may generate state information including a position thereof and an indication of whether the operation has been performed according to the instruction such that the sever 110 can determine a lighting device under which the unmanned guided vehicle 130 is positioned, and whether the operation has been performed according to the instruction. The unmanned guided vehicle 130 transmits the state information to the lighting devices 120, 122, 124, and 126 over a visible light signal using the lighting unit. A detailed description of the unmanned guided vehicle 130 will be given with reference to FIGS. 4 and 5.

Here, the lighting device 120 or the unmanned guided vehicle 130 has an identifier which is information for identifying each of the lighting device or the unmanned guided vehicle. As the identifier, a unique production number assigned at the time of production of the lighting device or the unmanned guided vehicle may be used, or unique identification information such as, for example, an IP address or a MAC address on the network used by the lighting device may be used. The above-mentioned types of information are merely an example of the identifier, and the identifier includes any information by which each of the lighting device or the unmanned guided vehicle can be identified.

FIG. 2 is a configuration diagram of a server according to an embodiment of the present disclosure.

Referring to FIG. 2, a server 110 according to an embodiment of the present disclosure includes an input/output unit 210, a database 220, a data generator 230, a controller 240, and a communication unit 250.

The input/output unit 210 receives instructions input by the administrator of the unmanned guidance system 100. The input/output unit 210 may be implemented as an input device such as a keyboard, a mouse, or a touchscreen. The input/output unit 210 may receive an instruction, such as a waypoint or a final destination, from the administrator of the unmanned guidance system 100. Instructions that may be input by the administrator include a waypoint, a final destination, and an operational instruction for the user of the unmanned guided vehicle 130, such as an instruction to load specific parts, workpieces, etc., from the user of the unmanned guided vehicle 130 at the waypoint or final destination.

The input/output unit 210 outputs the state information about the unmanned guided vehicle 130 received from the lighting device 130. The state information about the unmanned guided vehicle 130 includes the current position of the unmanned guided vehicle 130. When the instruction includes an operational instruction for the user of the unmanned guided vehicle 130, the state information further includes information about whether the operation has been completed from the user of the unmanned guided vehicle 130. When the communication unit 250 receives the state information about the unmanned guided vehicle 130, the input/output unit 210 outputs the received state information such that the administrator of the unmanned guidance system 100 can check the state information. The input/output unit 210 can be implemented as any output device capable of transmitting specific information to humans, such as a sound device and a display unit.

The database 220 stores the identifiers of the lighting device and the identifier of the unmanned guided vehicle, and distinguishes each lighting device and each unmanned guided vehicle using the stored identifier of the lighting device or the unmanned guided vehicle. In order to receive specific data through visible light communication, the lighting device and the unmanned guided vehicle are pre-registered with the server 110. The lighting device and the unmanned guided vehicle are registered by transmitting the identifiers thereof to the server 110, and the server 110 stores the received identifiers of the lighting device and the unmanned guided vehicle in the database 220.

In addition, the database 220 stores a map of the space in which the unmanned guidance system 100 is operated. The map of the space in which the unmanned guidance system 100 is operated is shown in FIG. 5.

FIG. 5 is a diagram illustrating a map of a space in which an unmanned guidance system is operated according to an embodiment of the present disclosure.

As shown in FIG. 5, the database 220, which does not need to store all the positions of the facilities in the space in which the unmanned guidance system is operated, stores the positions of the lighting devices 120, 121, 122, 123 , 124, and 125 which are arranged in the space. Using the positions of the lighting devices stored in the database 220, the server 110 may determine a position in the space corresponding to a waypoint or final destination input through the input/output unit 210.

The data generator 230 generates data to be transmitted to the unmanned guided vehicle via the lighting device 120. The data consists of a header and a payload. The header of the data to be transmitted to the unmanned guided vehicle includes the identifier of the unmanned guided vehicle for identifying the unmanned guided vehicle for which the data is intended. The payload of the data to be transmitted to the unmanned guided vehicle includes instructions of the administrator. The data generator 230 generates control data including the above-described information in the header or payload thereof.

The controller 240 checks the instructions received through the input/output unit 210 and controls the data generator 230 to generate control data including the instructions. The controller 240 checks the instructions to determine which unmanned guided vehicle is to be controlled, to which position the unmanned guided vehicle is to be moved, and whether there is an operational instruction for the user of the unmanned guided vehicle. Upon determining which unmanned guided vehicle is to be controlled, the controller 240 checks the identifier of the unmanned guided vehicle in the database 220. Then, the controller performs a control operation to include the identifier of the unmanned guided vehicle in the data to be transmitted to the unmanned guided vehicle. In addition, the controller 240 performs a control operation to include the waypoint or final destination of the unmanned guided vehicle and the operational instruction for the user of the unmanned guided vehicle in the data to be transmitted to the unmanned guided vehicle. In this case, when the input/output unit 210 receives a specific position as the waypoint or the final destination, the controller 240 determines the position of a lighting device closest to the input position among the positions of the lighting devices stored in the database 220. The controller 240 performs a control operation to replace the position of the closest lighting device with the waypoint or the final destination so as to be included in the data to be transmitted to the unmanned guided vehicle.

The controller 240 controls the communication unit 250 to transmit the control data to the lighting devices 120, 122, 124, and 126.

The controller 240 analyzes the state information about the unmanned guided vehicle 130 received from the lighting device 130. The controller 240 checks the current position information about the unmanned guided vehicle 130 in the state information about the unmanned guided vehicle 130 to determine whether the unmanned guided vehicle 130 is operating as instructed. In addition, the controller 240 checks the information about whether the operation according to the operational instruction has been completed from the user of the unmanned guided vehicle 130, which is in the state information, to determine whether operation is being performed as instructed by the user of the unmanned guided vehicle 130. The controller 240 transmits the checked information to the input/output unit 210 such that the input/output unit 210 can output the state information about the unmanned guided vehicle 130.

The communication unit 250 transmits the control data to the lighting device 120 under control of the controller 240. The communication unit 310 includes a wired communication module and transmits the control data to the lighting device 120 by wire.

FIG. 3 is a configuration diagram of a lighting device according to an embodiment of the present disclosure.

Referring to FIG. 3, the lighting device 120 according to an embodiment of the present disclosure includes a communication unit 310, a controller 320, a data manager 330, a lighting unit 340, and a visible light receiver 350.

The communication unit 310 is connected to the server 110 using a wired communication module and receives control data from the server 110. In addition, the communication unit 310 transmits the state information about an unmanned guided vehicle regenerated by the data manager 330 to the server 110.

The data manager 320 analyzes the received control data and generates control data to be transmitted to the unmanned guided vehicle by the lighting unit 340 using visible light communication. The data manager 320 analyzes the received control data and divides the control data into a header and a payload of the control data. The data manager 320 may further include an identifier of the lighting device 120 in the header of the control data such that the unmanned guided vehicle 130 receiving the control data can identify the lighting device form which the control data is received. Accordingly, the header of the control data to be transmitted to the unmanned guided vehicle using visible light communication includes the identifier of the unmanned guided vehicle and the identifier of the lighting device transmitting the control data. The data manager 330 includes the entire information included in the payload of the received control data in the payload of the control data to be transmitted to the unmanned guided vehicle using visible light communication.

The data manager 320 regenerates the state information received from the unmanned guided vehicle 130 under control of the controller 330 such that the communication unit 310 can transmit the state information to the server 110 using a wired network. The data manager 320 includes position information about the unmanned guided vehicle in the payload of the state information under control of the controller 330 and regenerates state information such that the communication unit 310 can transmit the state information to the server 110 using the wired network.

The controller 330 controls the lighting unit 340 to transmit the control data generated by the data manager 320 using visible light communication.

The controller 330 analyzes the state information received from the unmanned guided vehicle 130 by the visible light receiver 350. The controller 330 analyzes the state information transmitted from the unmanned guided vehicle 130 and recognizes the identifier of the lighting device included in the state information. The controller 330 determines the lighting device under which the unmanned guided vehicle 130 is positioned, based on the identifier of the lighting device included in the state information transmitted by the unmanned guided vehicle 130. When an identifier of a lighting device including the controller 330 does not match the identifier of the lighting device included in the state information, the controller 330 does not proceed with any other processing because the unmanned guided vehicle 130 is not positioned under the lighting device including the controller 330. On the other hand, when both identifiers match each other, the controller 330 checks the strength or direction of the visible light signal (state information) received from the unmanned guided vehicle 130 by the visible light receiver 350. By checking the strength or the direction of the visible light signal (state information), the controller 330 may determine the position and distance of the unmanned guided vehicle 130 with respect to the lighting device in which the controller is included. After determining the position information about the unmanned guided vehicle 130, the controller 330 controls the data manager 320 to include the position information about the unmanned guided vehicle 130 determined by the controller 330 in the payload of the state information received from the unmanned guided vehicle 130. The controller 330 controls the communication unit 310 to transmit the state information including the position information about the unmanned guided vehicle 130 to the server 110.

The lighting unit 340 modulates the control data generated by the data manager 330 into a visible light signal and transmits the visible light signal to all unmanned guided vehicles within the transmission coverage of the visible light signal.

The visible light receiver 350 receives state information transmitted from an unmanned guided vehicle over a visible light signal. The visible light receiver 350 is implemented as a built-in or external visible light reception module for the lighting device and receives the state information transmitted from the unmanned guided vehicle 130 over the visible light signal.

FIG. 4 is a block diagram of an unmanned guided vehicle according to an embodiment of the present disclosure.

Referring to FIG. 4, an unmanned guided vehicle 130 according to an embodiment of the present disclosure includes a visible light receiver 410, a lighting unit 420, a data manager 430, a controller 440, a sensor unit 450, an input/output unit 460, a drive unit 470, and a database 480.

The visible light receiver 410 receives the control data from the lighting device 120. The visible light receiver 410 may be implemented as a built-in or external camera or visible light reception module in the unmanned guided vehicle 130 to receive control data transmitted over a visible light signal.

The lighting unit 420 modulates state information about an unmanned guided vehicle generated by the data manager 430 into a visible light signal and transmits the visible light signal to all lighting devices within the transmission coverage of the visible light signal.

The data manager 430 analyzes the received control data, and divides the control data into a header and a payload of the control data such that the controller 440 can check the header and the payload.

In addition, the data manager 430 generates state information such that the lighting unit 420 can transmit the state information to the lighting devices 120, 122, 124, and 126 under control of the controller 440 using visible light communication.

The controller 440 analyzes the control data and determines whether the control data is intended for the unmanned guided vehicle 130 in which the controller 440 is included. The controller 440 checks the identifier of an unmanned guided vehicle included in the header of the control data, and determines whether the control data is intended for the controller 440. When the control data is not data intended for the controller, the controller 440 does not proceed with any further operation. On the other hand, when the control data is intended for the controller 440, the controller 440 controls the unmanned guided vehicle 130 to operate according to the control data.

The controller 440 analyzes the control data to determine the position of the unmanned guided vehicle 130. The operation of the controller 440 of determining the position of the unmanned guided vehicle 130 through the control data is identical to the operation of the controller 330 in the lighting device 120 of determining the position of the unmanned guided vehicle 130 described with reference to FIG. 3. The controller approximately determines a lighting device under which the amended guided vehicle is positioned based on the identifier of the lighting device included in the header of the control data, and identifies the current position of the unmanned guided vehicle 130 by determining the strength and direction of the control data received over a visible light signal. When the controller 440 receives a plurality of control data from a plurality of lighting devices, the controller 440 determines the strength and direction of each control datum in the same manner as described above to determine a lighting device to which the unmanned guided vehicle is closer than to the other lighting devices. Thereby, the controller determines the current position of the unmanned guided vehicle 130.

The controller 440 analyzes the control data, recognizes the identifier of the lighting device corresponding to a waypoint or the final destination, and controls the drive unit 470 according to the recognition result. The controller 440 calculates the path of the unmanned guided vehicle 130 using the current position and the waypoint or final destination of the unmanned guided vehicle 130. The controller 440 controls the drive unit 470 to drive or rotate the unmanned guided vehicle 130 according to the calculated path.

In some implementations, when the strength of the visible light signal (control data) received by the visible light receiver 410 falls below a preset level, the unmanned guided vehicle 130 may be regarded as deviating from a certain path along which the lighting devices are arranged. In this case, the controller 440 may control the drive unit 470 to rotate the unmanned guided vehicle 130 by a preset angle or to stop the unmanned guided vehicle 130. Since the strength of the visible light signal (control data) received by the visible light receiver 410 falls below the preset level, the controller 440 performs the above-described control operation to stop travel of the unmanned guided vehicle 130 in the direction in which the unmanned guided vehicle is currently running. For example, when the strength of the visible light signal (control data) falls below the preset level, the controller 440 may control the drive unit 470 to rotate the unmanned guided vehicle to face in the opposite direction (rotation by 180 degrees).

When an operational instruction is included in the instructions of the administrator of the unmanned guidance system as a result of analysis of the control data, the controller 440 identifies the operational instruction and controls the input/output unit 460 to output the operational instruction. By controlling the input/output unit 460, the controller 440 allows the user of the unmanned guided vehicle 130 to check the instructions from the administrator of the unmanned guidance system. When the input/output unit 460 receives, from the user of the unmanned guided vehicle 130, completion of the operation according to the operational instruction, the controller 440 controls the data manager 430 to include the completion according to the operational instruction in the state information. Here, the controller 440 controls the input/output unit 460 to output the operational instruction, and then controls the drive unit 470 to stop driving of the unmanned guided vehicle 130 until it receives completion of the operational instruction from the user of the unmanned guided vehicle 130.

After the user of the unmanned guided vehicle 130 checks the instructions from the administrator of the unmanned guidance system, driving of the unmanned guided vehicle 130 is stopped for a predetermined period of time as described above in order to ensure the corresponding operation time.

The sensor unit 450 senses an obstacle located in front of or on a side of the unmanned guided vehicle 130. By pre-sensing the obstacle present on the path of the unmanned guided vehicle 130, the sensor unit 450 allows the unmanned guided vehicle 130 to avoid the obstacle or announces presence of the obstacle to the outside through the input/output unit 460.

The input/output unit 460 receives input from the user of the unmanned guided vehicle or outputs information to be delivered to the user of the unmanned guided vehicle. The input/output unit 460 outputs an operational instruction in the instructions from the administrator of the unmanned guidance system under control of the controller 440. By outputting the operational instruction, the input/output unit 460 allows the user of the unmanned guided vehicle 130 to check the operational instruction from the administrator of the unmanned guidance system. When the user of the unmanned guided vehicle 130 completes the operational instruction, the input/output unit 460 receives from the user of the unmanned guided vehicle 130 the completion of the operation according to the operational instruction, and transfers the input to the controller 440.

The drive unit 470 controls steering or driving of the unmanned guided vehicle 130. The drive unit 470 includes a steering unit (not shown) to rotate the unmanned guided vehicle 130 by a predetermined angle with respect to the travel direction. The drive unit 470 includes an accelerator (not shown) and a brake (not shown) to allow the unmanned guided vehicle 130 to travel in a specific direction or stop.

The database 480 stores a map of a space in which the unmanned guided vehicle operates. The map of the space in which the unmanned guided vehicle operates is shown in FIG. 5.

As shown in FIG. 5, the database 480, which does not need to store all the positions of the facilities in the space in which the unmanned guidance system is operated, stores the positions of the lighting devices 120, 121, 122, 123 , 124 and 125, and the identifier of each lighting device.

The controller 440 may recognize the position of the unmanned guided vehicle 130 by checking the identifier of the lighting device that has transmitted control data in the database 480. In addition, the controller 440 may recognize a waypoint or the final destination of the unmanned guided vehicle 130 by checking, in the database 480, the identifier of a lighting device corresponding to the waypoint or final destination included in the control data.

### DESCRIPTION OF REFERENCE NUMERALS

100: Unmanned guidance system
110: Server
120, 122, 124, 126: Lighting device
130: Unmanned guided vehicle
210, 460: Input/output unit
220, 480: Database
230: Data generator
240, 330, 440: Controller
250, 310: Communication unit
320, 430: Data manager
340, 420: Lighting unit
350, 410: Visible light receiver
450: Sensor unit
470: Drive unit

### CROSS-REFERENCE TO RELATED APPLICATIONS

This application claims priority to Korean Patent Application No. 10-2016-0164502, filed on Dec. 5, 2016. The entire contents of those are incorporated herein by reference.

1. An unmanned guided vehicle configured to move according to a visible light signal received from a lighting device, the unmanned guided vehicle comprising:
a visible light receiver configured to receive a visible light signal from the lighting device;
a data manager configured to demodulate the visible light signal into an electric signal to check data included in the visible light signal or to generate state information to be transmitted to the lighting device;
a lighting unit configured to modulate the state information into a visible light signal and transmit the visible light signal to the lighting device;
a drive unit configured to control steering and driving of the unmanned guided vehicle; and
a controller configured to analyze the data included in the visible light signal and control the drive unit to drive or rotate the unmanned guided vehicle.

2. The unmanned guided vehicle of claim 1, wherein the data included in the visible light signal comprises:
an identifier of a lighting device transmitting the visible light signal, an identifier of an unmanned guided vehicle to be controlled to operate according to the visible light signal, an identifier of a lighting device at a position to which the unmanned guided vehicle is to move, or instruction information to be delivered to a user of the unmanned guided vehicle.

3. The unmanned guided vehicle of claim 2, wherein the controller analyzes the data included in the visible light signal to determine whether an identifier of the unmanned guided vehicle including the controller matches the identifier of the unmanned guided vehicle to be controlled to operate according to the visible light signal,
wherein, when the identifiers match each other, the controller controls the drive unit to drive or rotate the unmanned guided vehicle.

4. The unmanned guided vehicle of claim 2, further comprising:
a database configured to store identifiers and positions of respective lighting devices present in a preset area.

5. The unmanned guided vehicle of claim 4, wherein the controller determines a position of the unmanned guided vehicle or a position to which the unmanned guided vehicle is to move by identifying, in the database, a position of a lighting device having an identifier matching the identifier of the lighting device transmitting the visible light signal or the identifier of the lighting device at the position to which the unmanned guided vehicle is to move.

6. The unmanned guided vehicle of claim 5, wherein the controller calculates a movement path of the unmanned guided vehicle by determining the position of the unmanned guided vehicle or the position to which the unmanned guided vehicle is to move, and controls the drive unit to drive or rotate the automatic guided vehicle along the calculated movement path.

7. The unmanned guided vehicle of claim 1, wherein, when a strength of the visible light signal received by the visible light receiver is lower than a preset strength, the controller controls the drive unit to rotate the unmanned guided vehicle by a preset angle or stop the unmanned guided vehicle.

8. The unmanned guided vehicle of claim 1, further comprising:
an input/output unit configured to output the data included in the visible light signal or whether the unmanned guided vehicle is driven or to receive input data from a user of the unmanned guided vehicle.

9. The unmanned guided vehicle of claim 2, wherein the input/output unit outputs the instruction information and receives an input of completion of an operation according to the instruction information from the user of the automatic guided vehicle.

10. The unmanned guided vehicle of claim 9, wherein, when the instruction information to be delivered to the user of the unmanned guided vehicle is contained in the visible light signal, the controller controls the drive unit to stop driving of the unmanned guided vehicle until the input/output unit receives the input of completion of the operation according to the instruction information from the user of the automatic guided vehicle.

11. The unmanned guided vehicle of claim 9, wherein the controller controls the data manager to generate the state information by including the identifier of the lighting device transmitting the visible light signal or a status of the completion of the operation according to the instruction information in the state information.

12. The unmanned guided vehicle of claim 8, wherein the input/output unit outputs the instruction information and receives an input of completion of an operation according to the instruction information from the user of the automatic guided vehicle.

13. The unmanned guided vehicle of claim 12, wherein, when the instruction information to be delivered to the user of the unmanned guided vehicle is contained in the visible light signal, the controller controls the drive unit to stop driving of the unmanned guided vehicle until the input/output unit receives the input of completion of the operation according to the instruction information from the user of the automatic guided vehicle.

14. The unmanned guided vehicle of claim 12, wherein the controller controls the data manager to generate the state information by including the identifier of the lighting device transmitting the visible light signal or a status of the completion of the operation according to the instruction information in the state information.
